(19) United States
(12) Patent Application Publication
(10) Pub. No.: US 2002/0169958 A1
(43) Pub. Date: Nov. 14, 2002

(54) Authentication in data communication

(76) Inventors: Kai Nyman, Espoo (FI); Mikko Olkkonen, Kikkonummi (FI); Jari T. Malinen, Mountain View, CA (US)

Correspondence Address: ROBERT C. ROLNIK, NOKIA INC., 6000 CONNECTION DRIVE, MD 1-4-755, IRVING, TX, 75039, US

(21) Appl. No.: 09/858,264

(22) Filed: May 14, 2001

(51) Int. Cl. H04L 9/00

(52) U.S. Cl. 713/168; 380/270; 380/249

(57) ABSTRACT

A client 110 may be authenticated by transmitting or beaming a telecommunication network subscriber's authentication to the client from a device 120, over a wireless link. For example, a GSM telephone 120 may authenticate an electronic book 110 to a content providing service within the Internet. The service verifies the authentication using the subscriber's GSM network operator's Authentication Center 161 to generate an authenticator and the client correspondingly generates a local copy of the authenticator using a GSM SIM over the wireless local link. The authentication is then determined by checking that these authenticators match and thereafter the authenticator can be used as a session key to encrypt data in the service.

### BACKGROUND

This invention relates to authentication in data communication. In particular the invention relates to, but is not limited to, authenticating mobile stations and network servers communicating with each other through a network.

The Internet is used to share public information. Since it is an open system, it should not be used to share confidential information unless precautions are taken to protect the information by use of passwords, encryption and the like. Even so, if passwords are used, hackers can determine them. In the Internet, there are clients, e.g. personal computers, and servers which may be server computers running computer programs that cause the servers to provide services to the clients. Typically computer programs used at clients and servers assume that their users are honest about their identity. Some client/server applications rely on the client to restrict its activities to those, which it is allowed to do, with no other enforcement by the server. Both clients and servers are entities.

Some sites use firewalls to improve their network security. Unfortunately, firewalls are based on an assumption of security threats come from the outside, which is not always the case. Computer crime can be carried out by insiders who have access to such private networks that are connected to the Internet by firewalls, that is intranets. These insiders can listen to the data traffic and detect passwords of the other users. Using these illegally obtained passwords, an insider can access such services to which he would not normally have access. In other words, firewalls can restrict viruses from accidentally contaminating an intranet, but they do not generally provide any certainty of the true authenticity of a client or server. Strong authentication is highly desirable for transactions involving money, confidential data or both.

One way to improve the situation is to use dedicated authentication protocols and, if necessary, encryption protocols for verifying the authenticity of a party and for preventing unauthorised parties from obtaining access. In addition, these protocols can typically be used to verify the integrity of any information exchanged over a link so that a recipient can be certain that the data received have not been tampered with.

The wireless use of a Subscriber Identity Module SIM is previously known in the context of lending a SIM from one mobile station to another mobile station. EP1075155 discloses an example of providing a wireless access to a SIM, in order to provide a user identity of a GSM device. One SIM can be alternately used by different GSM devices without physically transferring the SIM between these devices. This publication is referred to as an example on how a SIM can be accessed over a wireless link, although there one SIM is shared by two mobile stations.

WO 00/02407 discloses an invention wherein a laptop PC, provided with a Wireless Local Area Network (WLAN) adapter and a Global System for Mobiles (GSM) card phone, may access WLAN networks and authenticate a user by utilising a Subscriber Identity Module (SIM) card contained by the GSM card phone. Access to the local area network takes place e.g. with the aid of a LAN card in the terminal and to the GSM network with the aid of a GSM card phone, which in practice is a stripped telephone located e.g. in the laptop's expansion slot. In addition, a SIM is connected to the GSM card phone. In that publication, the SIM is used not only for authenticating in a GSM network, but for reliable authentication of a data terminal to a non-trusted data network, such as to a third-party Mobile Internet Protocol (MIP) network. The SIM is accessed using the SIM slot of the GSM card phone. In brief, the SIM is used for generating a correct response to a challenge originated from an Authentication Center (AuC) of the GSM network to which the SIM belongs. The response can only be correctly generated by the SIM that possesses a first shared secret or a secret key known or stored only by the SIM and the AuC. When a user desires to access a WLAN network, a following process is performed:

1. A Home agent (HA) fetches from the authentication center AuC located in connection with the home location register HLR of the mobile communications network a set of subscriber-specific authentication triplets, each of which contains a challenge or RAND, a signed response (SRES) and a GSM key, Kc, which is a connection-specific encryption key.

2. The challenge (RAND) in each authentication triplets are transferred further to the mobile node or terminal.

3. The terminal uses the SIM to generate a response and a GSM key, Kc, based on one of the challenges and a first shared secret, K_{I}, known only by the SIM and the AuC.

4. The terminal sends back the response to the HA for checking against the HA stored version of the response. Security Parameter Index (SPI) is used for carrying the SRES, and because some of the SPI values are received, they cannot be used. Therefore, the response not only acknowledges that the terminal has access to the SIM, but also identifies which one of many challenges has been used and corresponding GSM key, Kc, can be used.

5. The obtained GSM key, Kc, is used as a secret, the basis of which an authenticator is computed. The authenticator may to be used as a session key in, for example, Mobile IP networking.

Despite the technical advance of WO 00/02407, it still necessitates a data terminal to possess a SIM slot in order to be able to make use of the disclosed SIM based authentication. Furthermore, althouth a user may have separate SIMs for a personal GSM telephone and for a GSM card phone of a personal computer, he or she may only have or desire to use a single SIM alternately in either device.

The use of the word ‘known’ is synonymous with the word store. A device ‘knows’ information if the device stores that information in one or more registers or memories that are on, in or near a processor of the device in the sense that the information is readable or operable by the processor in a manner that is not susceptible to interception or corruption. Knowing has a time-factor as well. A first device may not know information during a brief instant, where one or more exchanges of messages between the device and a second device are required before the data of a second device is readable or operable by a processor of the first device, and yet the first device may know the information in the context of a larger period of time.

### SUMMARY OF THE INVENTION

It is an advantage of the method that the installed base of subscriber identification modules (e.g. GSM SIMs) can be readily used for authenticating each user in another communication system over a local wireless link. This enables a user to authenticate himself by using his/her own identity module without separately installing the identity module into a terminal being used for accessing that communication system.

A wireless link that comprises a communications link used by one or more embodiments may be based on protocols and media that include for example a Low-Power Radio-Frequency (LPRF) link, such as a Bluetooth link, an optical link, such as an infrared link, or an acoustic link such as an ultrasound link. Typically, the range of a local wireless link up to about 10 meters, which may vary according to sensitivity of antennas, positioning of devices in nulls, and other environmental factors. The accessing of the identity module over a local wireless link may permit enhanced flexibility by bringing e.g. SIM based authentication to devices that lack a subscriber identity module reader. For example, laptop computers commonly have an Infrared Data Association (IRDA) port which may support a local wireless link. In addition local wireless connectivity is expected soon in a number of different Bluetooth enabled mobile telephones and laptop PC adapters.

A mobile station, according to an embodiment, may be equipped with a subscriber identity module. Moreover, the mobile station may have a wireless transceiver for providing, among other things, access to data stored on the subscriber identity module. The mobile station may be, for example, a mobile telephone such as a GSM telephone, an UMTS (3^{rd} generation mobile telephone), or a GSM data adapter for a computer.

A method according to an embodiment may comprise a step of generating an authenticator to authenticate the use of a personal service. The generation of the authenticator may separate the ciphering used by the mobile telecommunications network from the key being used in obtaining services so as to reduce the risk of the mobile telecommunication network's ciphering becoming hacked open.

Embodiments may create an authenticator derived using at least one item selected from the group consisting of: the first secret, the second secret, a replay attack protection code and a mobile telecommunications key. The mobile telecommunications key is a GSM key (Kc). Providing that the client embodiment has access to a correct subscriber identity module, the first and second secrets are the same. Alternatively, another or both of the first and second secrets may be different derivatives of a portion of data producible by using the challenge.

The embodiments of one aspect also apply to various other aspects of the invention. In sake of brevity, the embodiments have not been repeated in connection with every aspect of the invention. A skilled reader will appreciate the advantages of the various aspects based on the advantages of the first aspect of the invention.

### BRIEF DESCRIPTION OF THE DRAWINGS

The invention will now be described, by way of example only, with reference to the accompanying drawings, in which:

FIG. 1 shows a and embodiment in a communication system and a mobile telecommunications network which may be used by an embodiment;

FIG. 2 shows a procedure in accordance with the preferred embodiment;

FIG. 3 shows a block diagram of a mobile station according to an embodiment; and

FIG. 4 shows a block diagram of a client according to an embodiment.

### DETAILED DESCRIPTION

The term separate refers to the fact that a first communication system is or can be operated by a different vendor, provider or carrier than a second communication system. Typically, the first communication system may use different access point or access points for connecting with the client, whereas the second communication system may have base transceiver stations for connecting with its subscribers. Two communication systems may also be separate in the sense that each has a separate authentication system or firewall that is centrally managed by different servers.

The secret of a SIM is said to be corresponding to a shared secret of a mobile telecommunication system if the mobile station has been provisioned to operate on the mobile telecommunication system, wherein the secret exists as a copy in an authentication block of the mobile telecommunication system.

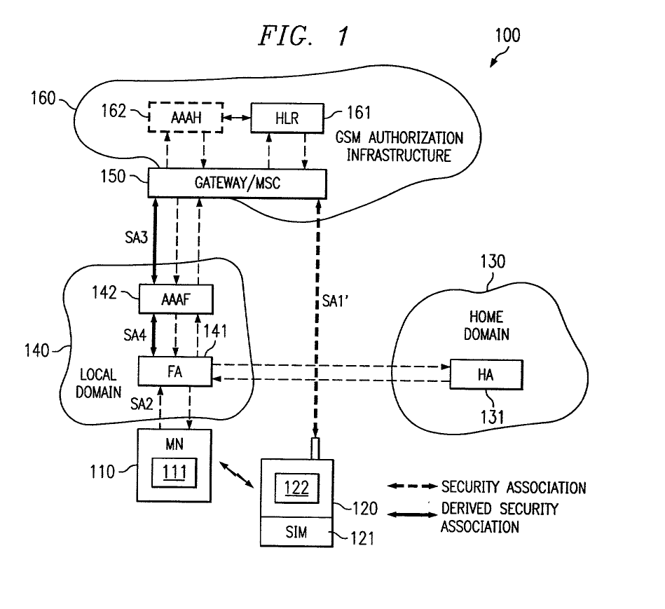

FIG. 1 shows a communication system 100 comprising a mobile telecommunications network 160, e.g. GSM, and a communication network, e.g. mobile internet protocol (MIP) network, containing a visited local domain 140 and a home domain 130. The system 100 further comprises a client, or Mobile Node, 110, which may communicate via an access point of the MIP network. The system additionally has a mobile station 120, e.g. a GSM telephone that may access the telecommunication network 160 through a base station. The mobile station 120 comprises a subscriber identity module (SIM) 121 in a SIM slot and a user interface 122. The home domain 130 comprises a home agent (HA) 131 that controls the access of the client 110 to other networks. For example, the home agent 131 may keep record of care-of (c/o) addresses to be used for granting clients access to visited visiting foreign domains, such as the local domain 140. The local domain 140 comprises a foreign agent that provides a c/o address to the client 110 and that the client can use as a proxy to access other networks and services. The local domain 140 further comprises a foreign Authentication, Authorisation, and Accounting block 142, (AAAF). The AAAF 142 may be accessed by the FA 141 and further has an access to the mobile telecommunication network 160 via a gateway 150. The telecommunications network 160 further comprises a home AAA (AAAH) block 162 for the client 110 and a Home Location Register (HLR) 161 having capability of an Authentication Centre (AuC). The gateway 150 allows communication between the AAAF 142 and the AAAH 162. One or more of the gateway 150, the HLR 161 and the AAAH 162 may comprise the authentication block.

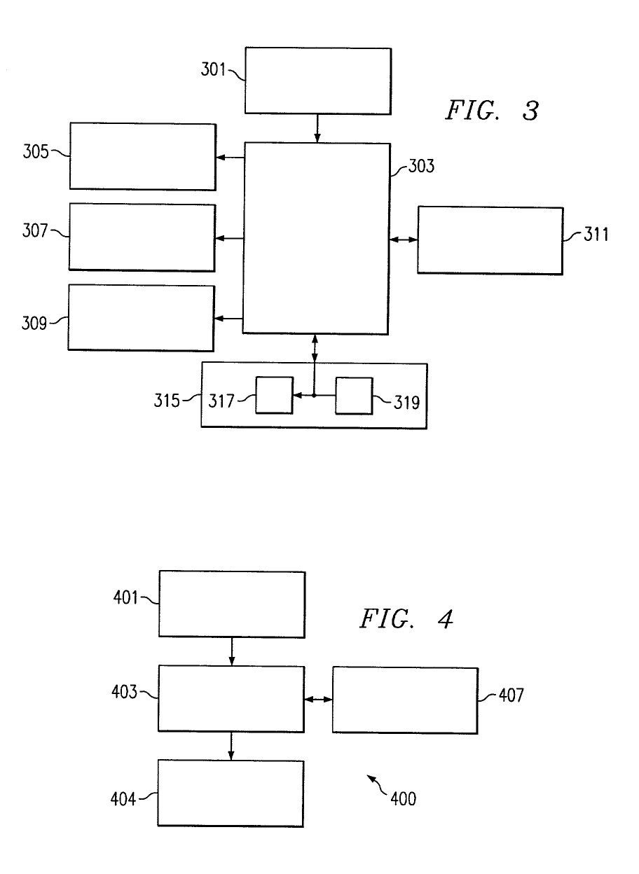

The client 110 may be a device having an interface with a data network (see FIG. 4), for example the Internet. The client 110 may be, for example, a laptop computer capable of communicating with a Local Area Network, Mobile IP network or Bluetooth network. The communications between the client 110 and the data network may use wireless signals such as Low Power Radio Frequency, e.g. Bluetooth communications, light signals, e.g. infrared beams, or acoustic signals e.g. ultrasound. A client 110 may be, for example, an electronic book, an electronic gaming device, or a Personal Digital Assistant (PDA) device. The client has a user interface 111 for outputting and inputting data to and from its user.

FIG. 1 also illustrates the different communications paths used for authenticating the client 110 and correspondingly generating an authenticator for a service. Each path may be a wireless link that occurs by radio frequencies, optical frequencies or sound. Single dashed lines show the paths used for authenticating and double lines show the security associations formed during the authentication process. Additionally, a security association 190 exists between the mobile station 121 and the gateway 190. This security association represents the authorisation that may be made between a mobile station and a mobile telecommunications network if the mobile station is used normally, for example for making a mobile telephone call. The gateway 150 may operate as a Mobile Services Switching Centre (MSC).

It is worth noting that all the blocks 131, 141, 142, 162 and 161 are typically implemented by means of software and servers located in various networks. These blocks can alternatively be distributed virtually anywhere around the world.

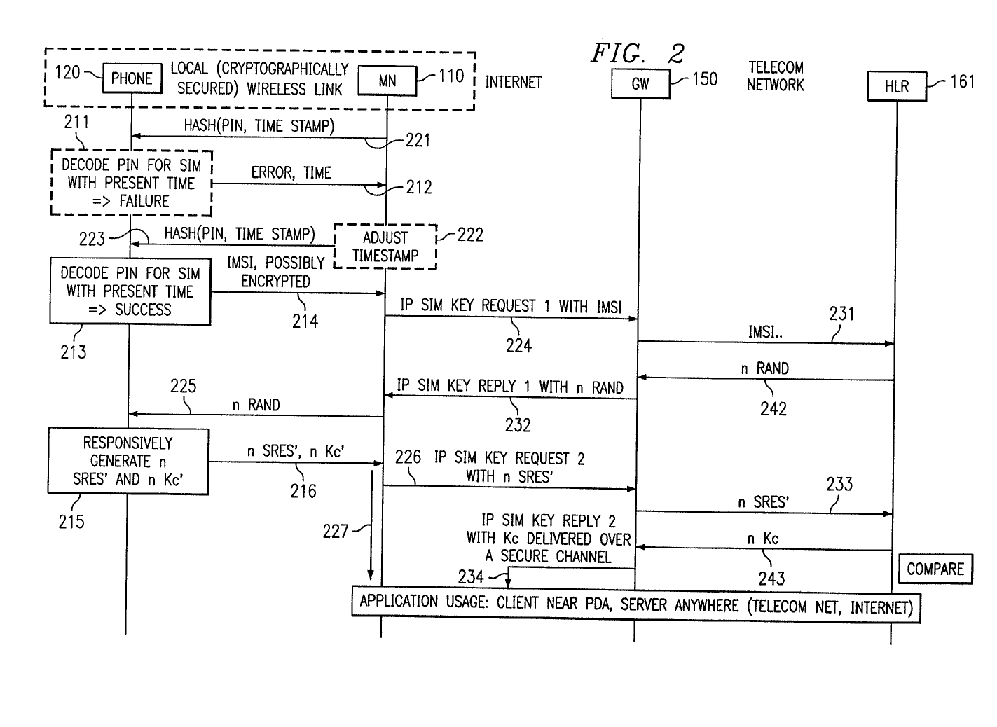

FIG. 2 shows a procedure starting from a situation in which a user positions a client 110 near a mobile station 120 containing a SIM 121 that the user is entitled to use. The user knows a personal identification number (PIN). A user starts the authentication process of an embodiment by entering, by way of the user interface 111, the PIN to the client 110. The client 110 may then encrypt the PIN by using a random replay attack protection coding such as a one-way hash function, wherein the PIN and a time stamp are encrypted so that a resultant coded signal is decryptable by the mobile station 120. When the client sends either the PIN or an encrypted PIN, the client is sending a request. The coded signal or encrypted PIN may be then sent over a local wireless link 191 to the mobile station 120, step 221.

A mobile station 120 may receive the request. The mobile station 120 may decode or decrypt the request if it contains an encrypted PIN and check 211 whether the PIN of the request correctly matches a PIN stored on the SIM. Errors may be caused if the mobile station 120 and the client 110 are not synchronised with the same time. In which case the mobile station 120 may send an error message 212 indicating that the time stamp should be verified. The client 110 may adjust the time stamp 222 and may send a second encrypted PIN 223. The mobile station 120 may receive the second encrypted PIN and may calculate whether it is correct for the SIM 213. If yes, then the procedure may continue. Either the checking step 211 or the calculating step 213 may retrieve a subscriber identity from the subscriber identity module, providing in either step, that the PIN received at the mobile station 120 is correct for the PIN stored in the SIM. The mobile station 120 may confirm that the PIN of the request matches an identity module PIN by way of either the checking step 211 or the calculating step 213, for example.

Next, the mobile station 120 may send its subscriber identity 214, typically an international mobile subscriber identity (IMSI). The IMSI may be sent in encrypted form. Alternatively a subscriber identity that is an index corresponding to the IMSI may be sent to the client 110 if the client 110 or any entity accessible to it has a mapping between the index and the IMSI. Such a mapping is useful in the sense that it conceals the IMSI by refraining from transmitting the IMSI over the local wireless link 191. Thus the risk is lowered that a third party captures and decrypts the IMSI.

Now that the client 110 knows the IMSI or its equivalent, client 110 may send 224 an IP SIM Key Request 1 with the IMSI to the gateway 150. The gateway 150 may forward the IMSI to the HLR 161. The HLR 161 may generate a number of authentication triplets, e.g. GSM triplets, typically in amounts up to three triplets. The HLR 161 then replies 242 with a predetermined number (n) of challenges, e.g. RANDs, to the gateway 150. The gateway 150 may send 232 an IP SIM key Reply 1 with n challenges to the client 110.

After receiving the challenges, the client 110 should prove its authorisation to act as a person whose identity the SIM possesses. The client 110 may access the SIM again by sending 225 the n challenges to the mobile station 120. The mobile station may then generate 215 at least one first secret, which may include n signed responses (SRES′). The at least one first secret may comprise GSM keys, e.g. mobile telecommunications keys, Kc′, by using its SIM. The copies of the signed responses and GSM keys generated by the SIM are locally produced copies and as they might differ from those generated by the HLR, if the SIM was wrong, a notation SRES′ and Kc′ is used respectively. The mobile station 120 then sends 216 these challenges and at least one first secret to the client 110.

The first secret may include one or more signed responses, e.g., the GSM specified signed Response (SRES). The secret specific to the subscriber identity is a secret known only by the subscriber identity module and the authentication block. One such example of a secret specific to the subscriber identity is the GSM specified Ki.

The client may receive the at least one first secret and GSM keys that the mobile station may send 216. The client 110 only needs to have the at least one first secret verified by the HLR 161 before the client 110 can form an authentication key for using a desired service. The client 110 sends 226 the at least one first secret to the gateway 150 in an IP SIM Key Request 2. The gateway 150 may forward 233 the at least one first secret to the HLR 161, which compares 239 the at least one first secret against at least one second secret, e.g. the secret generated at the HLR or Kc. If comparison 239 indicates they match, the SIM used must be correct. After the HLR 161 determines that the SIM is correct, the HLR 161 may reply to the gateway 150 by sending the second secret, which may be GSM keys, e.g. n Kc. The gateway 150 sends 234 these GSM keys to the HA 131 via the FA 141 (see FIG. 1). The FA may then grant access to the desired service for the client when the client 110 proves its identity using 227 the at least one second secret, e.g. the secret generated at the HLR or Kc.

The grant of access by a communication network to a client typically involves generation of an authenticator which may be an encrypted message based on, e.g., the at least one second secret. The at least one second secret may be encrypted by a one-way hash function of the GSM keys and of a time stamp or a replay attack protector as known in the art. The replay attack protector is typically a random number generated by the client 110. In order to use the same replay attack protector in the generation of the authenticator, the client 110 may send a replay attack protector to the FA 141, typically in the IP SIM Key request 1, step 224, which may pass through the FA 141. Alternatively, an authenticator may be based on one or more Kc, e.g. an encrypted Kc. Authenticator factors may be the at least one first secret and the at least one second secret, to the extent the authenticator is based upon the GSM keys or at least one second secret.

The desired service may be any personal or otherwise limited access service. Such services include, voice communications (e.g. voice over IP), e-mail, instant messaging, e-commerce. In addition, text chat, voice chat, prepaid or account based access on the Internet, personal address book hosting, personal calendar hosting, may be desired services. Desired services may include access to a restricted access file system, e.g. a corporate file system, or access to a restricted access data network, e.g. a corporate intranet. Desired services may also include, access to a restricted access database, e.g. a corporate data base, access to a MIP network, or access to a Wireless Local Area Network WLAN.

The authenticator may be valid for a predetermined time period, or it may be otherwise re-generated while a service is being used. According to alternative embodiments, an expired authenticator may be used until the use of a desired service ends. Alternatively a home domain may require that a new authenticator be generated on expiration of the previous authenticator, before the use of the service can be continued. The process for obtaining a new authenticator may be the same as described in connection with FIG. 2. Alternatively, the process starts from step 224, if the client has stored the identity of the identity module and if the same device (mobile telephone) is used to transmit the authentication to the client. In this case the PIN code need not be re-sent over the local wireless link merely for refreshing the authenticator and the authenticator can be refreshed automatically without user interaction.

The above-described process of obtaining an identity from a subscriber identity module and of further accessing the SIM for further generation of responses and keys may be referred to as beaming. The SIM capability may be beamed to the client 110 for an authentication purpose. The mobile station 120 carrying the SIM need not be switched off. Moreover, the mobile station 120 may be configured such that it can perform the beaming even while being used, e.g. for voice transmission or reception.

While the preferred embodiment as described was based on comparing the secrets provided by the AuC and by the SIM, the subscriber identity module access may be combined with other subscriber identity module based authentication procedures and protocols. For example, the a SRES may be replaced with one-way hashed codes as alternative secrets. The different embodiments of the invention may be scaleable to any particular subscriber identity module based authentication of a client to a communication system separate from the telecommunication network to which that module actually belongs. The subscriber identity module may be such a device that it can produce a response and a key corresponding to a challenge in a manner such that unauthorised third parties cannot easily detect. A GSM SIM is a good example of such, but the subscriber identity modules for various other purposes can equally be used, provided an access and co-operation can be arranged with the respective Authentication center in order to obtain relevant challenges, responses and keys.

FIG. 3 shows a block diagram of a communication device that may carry out the functions and equivalents described herein, such as, e.g. those functions of a mobile station shown in FIG. 2. A user interface device 301 receives inputs. Such inputs may be associated with characters, symbols and functions. The character-entry device may depend on pressure, e.g. such as to a keypad to take character and other inputs. Character-entry device may provide characters and other inputs encoded by means known in the art to an embedded processor 303. Embedded processor 303 may provide outputs that are discernable to human beings in several forms, including visual displays, audio, and vibrations, which may be provided by a display screen 305, speaker 307 and vibrate motor 309 respectively. Processor 303 may store and retrieve information from memory 311. Memory 311 may be pre-programmed with data and instructions. Memory 311 may include a removable media such as a SIM. Communication device may be able to communicate with other devices through a transceiver 315. Transceiver 315 may be able to transmit and receive signals as electromagnetic signals or sound. At a minimum, transceiver 315 may be a transmitter 317. Transceiver may also include a receiver 319. A mobile station may have multiple transmitters and receivers. Some transmitters may have an effective range that is long range. Some transmitters may have an effective range that is short range, or local.

FIG. 4 shows an apparatus that may provide the functions of a client, e.g. as described in FIG. 2. Client 400 may be comprised of a receiver 401, providing data signals to an embedded processor 403. Embedded processor may communicate by wireless through transmitter 404. Transmitter and receiver may operate alone, or in coordination to beam information to and from the client 400. In addition, processor 403, may rely on memory 407.

Particular implementations and embodiments of the invention have been described. While IP networks have been used to exemplify the invention, various other types of data networks are similarly applicable. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1. A method of authenticating a client to a communication system comprising the steps of
receiving from a mobile station a subscriber identity corresponding to a subscriber of a mobile telecommunication network, wherein the mobile telecommunication network is separate from the communication system to which the client is to be authenticated;
sending the subscriber identity to an authentication block of the mobile telecommunication network;
receiving from the authentication block at least one challenge and at least one first secret based on a subscriber's secret specific to the subscriber identity;
sending the at least one challenge to the subscriber identity module;
receiving at least one second secret in response to the at least one challenge; and
using the second secret for authenticating the client.

2. The method of authenticating of claim 1 further comprising:
receiving a PIN from a user; and
transmitting wirelessly the PIN to the mobile station.

3. The method according to claim 2 further comprising:
encrypting the PIN before the step of transmitting.

4. The method according to claim 1 wherein the step of using further comprises:
encrypting the second secret to provide a encrypted second secret; and
transmitting the encrypted second secret to the communication system.

5. The method according to claim 4 wherein the step of using further comprises:
refreshing the encrypted second secret.

6. The method according to claim 1 wherein the step of sending the subscriber identity to an authentication block comprises sending wirelessly the subscriber identity to the authentication block; and the step of receiving from the authentication block comprises receiving wirelessly from the authentication block.

7. The method according to claim 1 wherein the steps of
receiving from a mobile station a subscriber identity comprises receiving wirelessly from a mobile station a subscriber identity;
sending the at least one challenge comprises sending wirelessly the at least one challenge; and
receiving at least one second secret comprises receiving wirelessly at least one second secret.

8. The method of authenticating of claim 7 further comprising:
receiving a PIN from a user; and
transmitting wirelessly the PIN to the mobile station.

9. The method of authenticating of claim 8 wherein the step of transmitting wirelessly comprises transmitting an infrared signal.

10. The method of authenticating of claim 8 wherein the step of transmitting wirelessly comprises transmitting a radio signal.

11. The method of authenticating of claim 8 wherein the step of transmitting wirelessly comprises transmitting a low power radio signal.

12. The method of authenticating of claim 8 wherein the step of transmitting wirelessly comprises transmitting an acoustic signal.

13. A client for authenticating a client to a communication system comprising:
a means for receiving from a mobile station a subscriber identity corresponding to a subscriber of a mobile telecommunication network, wherein the mobile telecommunication network is separate from the communication system to which the client is to be authenticated;
a means for sending the subscriber identity to an authentication block of the mobile telecommunication network;
a means for receiving from the authentication block at least one challenge and at least one first secret based on a subscriber's secret specific to the subscriber identity;
a means for sending the at least one challenge to the subscriber identity module;
a means for receiving at least one second secret in response to the at least one challenge; and
a means for using the second secret for authenticating the client.

14. The client for authenticating of claim 13 further comprising:
a means for receiving a PIN from a user; and
a means for transmitting wirelessly the PIN to the mobile station.

15. The client according to claim 14 further comprising:
a means for encrypting the PIN before the step of transmitting.

16. The client according to claim 13 wherein means for using further comprises:
a means for encrypting the second secret to provide a encrypted second secret; and
a means for transmitting the encrypted second secret to the communication system.

17. The method according to claim 16 wherein the step of using further comprises:
refreshing the encrypted second secret.

18. The client according to claim 13 wherein the a means for sending the subscriber identity to an authentication block comprises a means for sending wirelessly the subscriber identity to the authentication block; and the a means for receiving from the authentication block comprises a means for receiving wirelessly from the authentication block.

19. The client according to claim 13 wherein
a means for receiving from a mobile station a subscriber identity comprises a means for receiving wirelessly from a mobile station a subscriber identity;
a means for sending the at least one challenge comprises a means for sending wirelessly the at least one challenge; and
a means for receiving at least one second secret comprises a means for receiving wirelessly at least one second secret

20. The client of claim 19 further comprising:
a means for receiving a PIN from a user; and
a means for transmitting wirelessly the PIN to the mobile station.

21. The client of claim 19 wherein the a means for transmitting wirelessly comprises a means for transmitting an infrared signal.

22. The client of claim 19 wherein the a means for transmitting wirelessly comprises a means for transmitting a radio signal.

23. The client of claim 19 wherein the a means for transmitting wirelessly comprises a means for transmitting a low power radio signal.

24. The client of claim 19 wherein the a means for transmitting wirelessly comprises a means for transmitting an acoustic signal.

25. A method for providing at least one secret based on a subscriber identity comprising the steps of:
retrieving from a subscriber identity module a subscriber identity corresponding to a subscriber of a mobile telecommunication network;
sending wirelessly the subscriber identity to a client for authenticating the client to the communication system;
receiving wirelessly from the client at least one challenge based on a subscriber's secret specific to the subscriber identity;
generating at least one secret in response to the at least one challenge and
sending wirelessly the at least one secret.

26. The method of claim 25 wherein the method further comprises a step of wirelessly receiving a request.

27. The method of claim 26 wherein the request contains a PIN.

28. The method of claim 27 wherein the request contains an encrypted PIN.

29. The method of claim 27 further comprising a step of confirming that the PIN matches a identity module PIN.

30. A mobile station for providing at least one secret based on a subscriber identity comprising:
means for retreiving from a subscriber identity module a subscriber identity corresponding to a subscriber of a mobile telecommunication network;
means for sending wirelessly the subscriber identity to a client for authenticating the client to the communication system;
means for receiving wirelessly from the client at least one challenge based on a subscriber's secret specific to the subscriber identity;
means for generating at least one secret in response to the at least one challenge and
means for sending wirelessly the at least one secret.

31. The mobile station of claim 30 wherein the method further comprises a means for wirelessly receiving a request.

32. The mobile station of claim 31 wherein the request contains a PIN.

33. The mobile station of claim 32 wherein the request contains an encrypted PIN.

34. The mobile station of claim 32 further comprising means for confirming that the PIN matches a identity module PIN.
